(19) United States
(12) Patent Application Publication
(10) Pub. No.: US 2012/0047028 A1
(43) Pub. Date: Feb. 23, 2012

(54) METHODS IN ADVERTISING SYSTEMS

(76) Inventors: Robert EDMAN, Uppsala (SE); Jonny EDMAN, Alvsjo (SE)

(21) Appl. No.: 12/860,982

(22) Filed: Aug. 23, 2010

(51) Int. Cl. G06Q 30/00; G06F 3/01

(52) U.S. Cl. 705/14.73; 715/733

(57) ABSTRACT

The present invention relates to methods in server applications providing releasing an ad, updating ad information of an ad for a dedicated ad space of a web site and maintaining that ad information of a release of an ad is kept updated. The methods provide numerous advantages of enabling up-dating an ad in essentially real-time, easiness to update of an ad being presented, to mention a few only.

### TECHNICAL FIELD

The present invention relates generally to methods in advertising systems, in particular it relates to methods for updating of ads in advertising systems.

### BACKGROUND

Within advertising systems known, a customer typically contacts an advertising department of a web page, at which the customer wants to advertise. The advertising department provides advertisement identification information to the customer. Using this ad ID the customer can create an ad on his own or by letting a web agency create the ad. The customer or web agency then sends the ad to the web page at which the ad is to be presented. The web page may then send the ad to a web ad presenting agency, for managing the ad, making a link between the ad and the web page, and returning the link to the web page. The web site company can then import the received ad link on their web page, such that the ad is displayed on their web page when displaying the web page.

After the customer has submitted his ad for publication to the web page, the lay-out and content of the ad is fixed, for which reason the ad will be published accordingly.

Needles to say an agreement between the web page and the customer may be established specifying the time and duration for publication of the ad.

There is a drawback with such an advertising system since the customer has limited or no possibilities to change or modify his ad, after submission.

In addition, when a visitor visits a web site 102 having one or more ads created by the use of certain programs, the visitor's web browser may request permission to install a plug-in program or third party program code to be able to present the ad information of the ad. A number of drawbacks are associated with such ads. Firstly, having to respond to the request is annoying to the visitor. Secondly, there is a safety hazard with permitting plug-ins such as Adobe Flash or third party program codes to be installed in the web browser's computer, since the request may be fraudulent and can contain malicious program code. Thirdly, the overall computer performance is often degraded with the installation plug-ins or third party program code.

There is hence a need for a more flexible way to provide advertising for advertisers.

### SUMMARY

It is an object of the present invention to provide updating of an ad essentially in real-time.

According to an aspect there is provided a method in a server application of releasing an ad for a dedicated ad space of a web site, comprising the steps of:
obtaining advertiser input data comprising data of selecting the dedicated ad space,
generating a web based ad file based on the received advertiser input data by an ad server, wherein the web based ad file is configured to disclose the ad when being linked to,
receiving ad information defining the ad from the advertiser
storing the web based ad file in a storage unit accessible from a web server,
determining in the web based ad file a connection to the received ad information, and
linking a web address of the dedicated ad space and the web based ad file, for releasing the ad in the dedicated ad space essentially in real-time by a web server upon visiting the web site comprising the dedicated ad space.

The step of obtaining advertiser input data of the method of releasing an ad for a dedicated ad space of a web site, may comprise obtaining selection of a web based ad file template having data fields for defining the web based ad file, wherein the step of generating a web based ad file comprises generating the web based ad file using the web based ad file template, based on advertiser input data.

The step of receiving ad information of the method of releasing an ad for a dedicated ad space of a web site, may comprise receiving text data, and wherein the method further comprises storing the received text data in a database.

The step of receiving ad information of the method of releasing an ad for a dedicated ad space of a web site, may comprise receiving image data, and wherein the method further comprises storing the received image data in a data storage that is accessible by the web server.

The step of obtaining advertiser input data of the method of releasing an ad for a dedicated ad space of a web site, may comprise obtaining data related to the size of the dedicated ad space.

The step of linking the web address of the dedicated ad space and the web based ad file of the method of releasing an ad, may comprise providing an uplink from the web address of the dedicated ad space via a proxy web page redirecting the uplink from the web address of the dedicated ad space to said web based ad file.

The step of linking the web address of the dedicated ad space and the web based ad file of the method of releasing an ad, may comprise providing a downlink from the web based ad file to the web address of the dedicated ad space, for providing a direct access for the web based ad file to the web address of the dedicated ad space.

The method of releasing an ad may comprise obtaining meta tags related to the ad information, enabling indexing of the web based ad file by search engines.

The step of receiving the ad information of the method releasing an ad, may comprise receiving an address of a dataflow of ad information.

According to another aspect there is provided a method in a server application of updating ad information of an ad for a dedicated ad space of a web site, wherein a web address of the dedicated ad space is linked to a web based ad file configured to disclose the ad when being linked to, where the ad is based on ad information that is stored and accessible by the web based ad file, the method comprising the steps of:
receiving first ad information,
obtaining information at least related to second ad information stored in a data source,
comparing first ad information and the information at least related to second ad information stored in the data source, and
updating the second ad information stored in the data source according to the received first ad information, in the case a difference is determined in the comparison, so that the ad based on second ad information being updated essentially in real-time.

The method for updating ad information, may comprise storing said first ad information in a database, wherein storing creates time related data that is related to time of storing the said data.

The time related data that is created by storing said first ad information in a database of the method for updating ad information, may comprise a counter or a time stamp.

Ad information in the step of receiving first ad information of the method for updating ad information, may comprise an ad information selection indicator

The ad information selection indicator in the method for updating ad information, may comprise an event related logical flag or a unique parameter value.

According to further aspect there is provided a method in a server application for maintaining that ad information of a release of an ad is kept updated, essentially in real-time for a dedicated ad space of a web site, wherein a web address of the dedicated ad space is linked to a web based ad file configured to disclose the ad when being linked to, where the ad is based on ad information that is stored and accessible by the web based ad file, the method comprising the steps of:
obtaining information at least related to first ad information,
obtaining information at least related to second ad information stored in a data source,
comparing data fields or time related data of information at least related to first ad information and the information at least related to second ad information stored in the data source, and
updating the access to ad information in the web based ad file, based on said comparison of data fields or time related data.

The step of updating the access to ad information in the web based ad file in the method for maintaining that ad information of a release of an ad is kept updated, may comprise updating the access to the first ad information in the case a difference is detected in the data fields or in said time related data.

The method for maintaining that ad information of a release of an ad is kept updated may further comprise obtaining detection of an event, wherein the step of updating comprises updating the access to ad information related to the detected event.

The ad information related to the detected event, in the method for maintaining that ad information of a release of an ad is kept updated, may comprise a first ad information selection indicator, wherein the step of updating comprises updating the access to ad information related to the detected event, is performed according to the first ad information selection indicator.

The first ad information selection indicator, in the method for maintaining that ad information of a release of an ad is kept updated, may comprise an event related logical flag or a unique parameter value.

The information at least related to first ad information and the information at least related to second ad information of the method for maintaining that ad information of a release of an ad is kept updated, may each comprise a counter or a time stamp, wherein the step of comparing data fields or time related data of information may comprise comparing data fields, counters or time stamps of said information, and wherein the step of updating the access to ad information in the web based ad file may be performed if there is at least one difference detected in at least one of the data fields, the counters and the time stamps.

Among the advantages with embodiments of the present invention can be mentioned:

It is advantageous that an advertiser can quickly and easily update ad information.

It is also advantageous that such ad information can be updated in essentially real-time.

It is further advantageous that a web site having an ad, does not need to be updated in order to present an updated version of the ad. Updating of ad is thus managed independent of the updating of the web page of a web browser.

Dynamic advertisements can be presented without the need to install or accept plug-ins or third party program code being installed on he visitor's computer, which certainly is advantageous since installing plug-ins and third party program code is a hazardous and is a pronounced risk for the reason that unwanted program code may as well or instead be installed, which may threaten the entire computer with contents.

### BRIEF DESCRIPTION OF DRAWINGS

In order to explain advantages and features of the present invention herein in more detail a few embodiments will be described below, where references are made to the accompanying drawings, for which

FIG. 1 illustrates an advertising system related to the present invention; and

FIGS. 2-5 illustrate information flow diagrams relating to methods steps of embodiments of the present invention.

### DETAILED DESCRIPTION

Prior art fails to provide easy access to updating of ads and to enable essentially real-time updating of ads. It should be noted that updating of ads refers herein to updating of ad information i.e. such as text data, images, colors and the like.

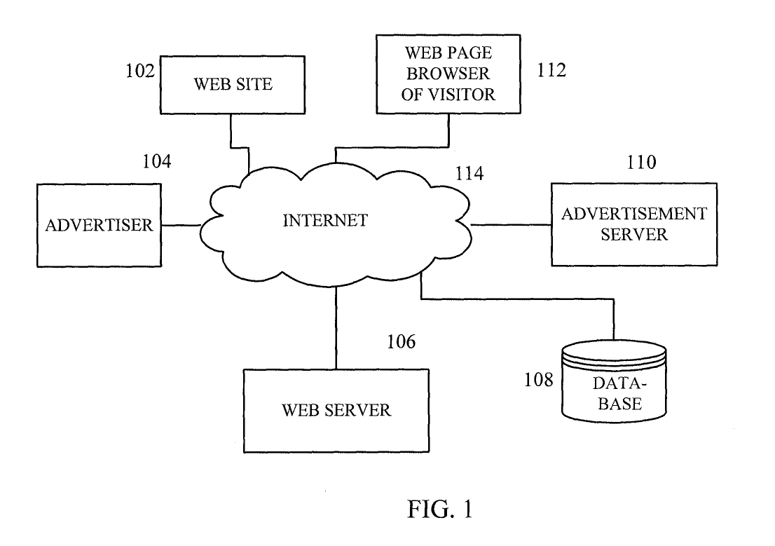

FIG. 1 illustrates one example of an advertising system related to the present invention. The system as illustrated comprises a web site 102, an advertiser node 104, a web server 106, a database 108, an advertisement server or simply ad server 110, a web page browser 112 and a network connecting these items such as the Internet 114.

It should be mentioned that the web server 106, the database 108 and the ad server 110, are items at least related to embodiments of the present invention.

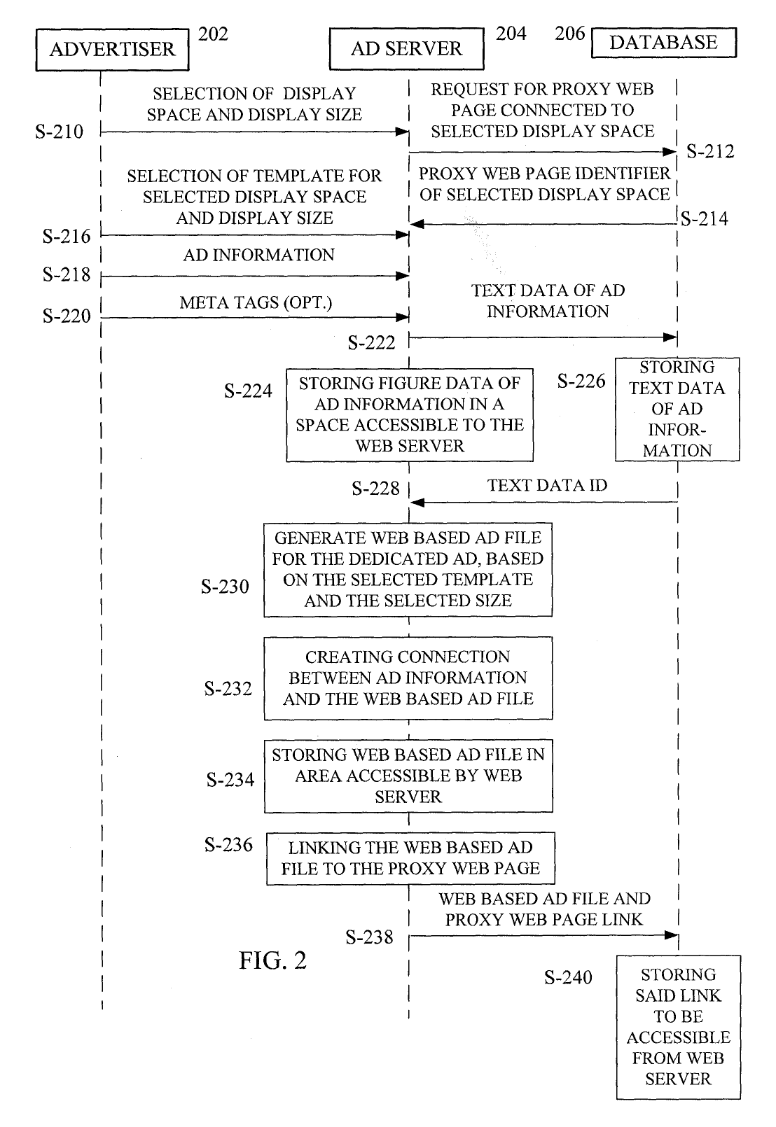

FIG. 2 illustrates an information flow diagram related to steps within a method in a server application in an ad server 204 of releasing an ad for a dedicated ad space of a web site. The method may start with receiving a selection of display space and display size of an ad from an advertiser 202 intending to publish ad information, S-210.

The display space here and display size here refers to the ad to be published at for instance a major newspaper.

Having received space and size selection the ad server may then send a request to the database 206 for identification data of a proxy web page, located on the web server 106, which proxy web page is connected to the selected display space, step S-212.

It should be mentioned that each display space in is beforehand connected to a specific proxy web page for which reason the database has access to this data. In step S-214 the ad server obtains a proxy web page identifier of the selected display space from the database 206.

The advertiser may also select a template form for filling data related to the ad. In step S-216 the ad server may thus receive such a template form for the selected display space and display size.

Having obtained a template, the ad server can now receive ad information from the advertiser in step S-218. Ad information here refers to text data, images, colors etcetera which the advertiser would to present to the public in the selected ad space.

It should be noted that the step of receiving ad information by the ad server 204 may in step S-218 comprise receiving an address of a dataflow of ad information. Ad information may then be received by the ad server from said address.

Optionally, the advertiser may provide meta tags for the ad in step S-220, wherein the meta tags may comprise additional relevant information connected to the ad information already provided. Having access to the ad information as obtained in step S-218 and to meta tags as obtained in step S-220, the ad server can now send text data as comprised therein to the database 206 in step S-222.

The ad server stores image data of the ad information in a storage space or in a file system that is accessible by a web server in step S-224. This web server is included in FIG. 1 and enumerated 106.

Text data that has been transferred to the database 206 in step S-222 is stored in the database 206 in step S-226, after which a text data identifier (ID) is returned to the ad server in step S-228. Rather than transferring text data itself, a text data ID is preferably transferred specifying the location within the database by the identifier in this case. The text data ID is a unique identifier identifying the text data, and may comprise an N-bit number, where N can be any multiple of two, for instance 32, 64, or 128. One example is the Globally Unique Identifier (GUID), which is a unique reference number, represented as a 32 character hexadecimal string, and usually stored as a 128 bit integer.

Based on the template and the selected display size the ad server may now generate a web based ad file for the dedicated ad, in step S-230. It can be noted that one web based ad file is generated per ad, having an associated template and display size.

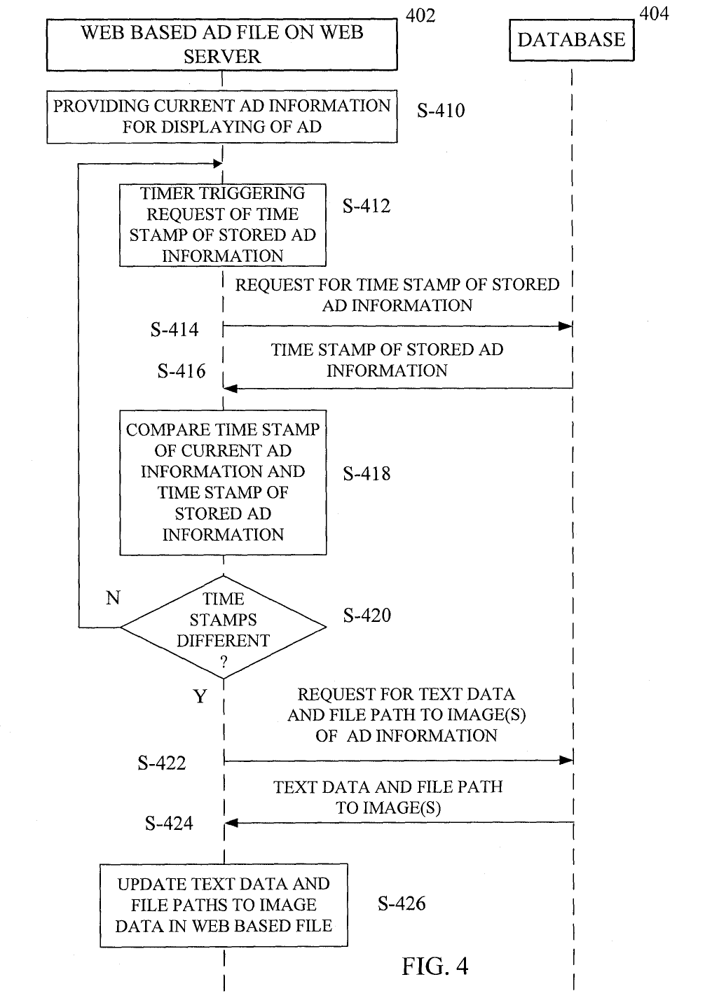

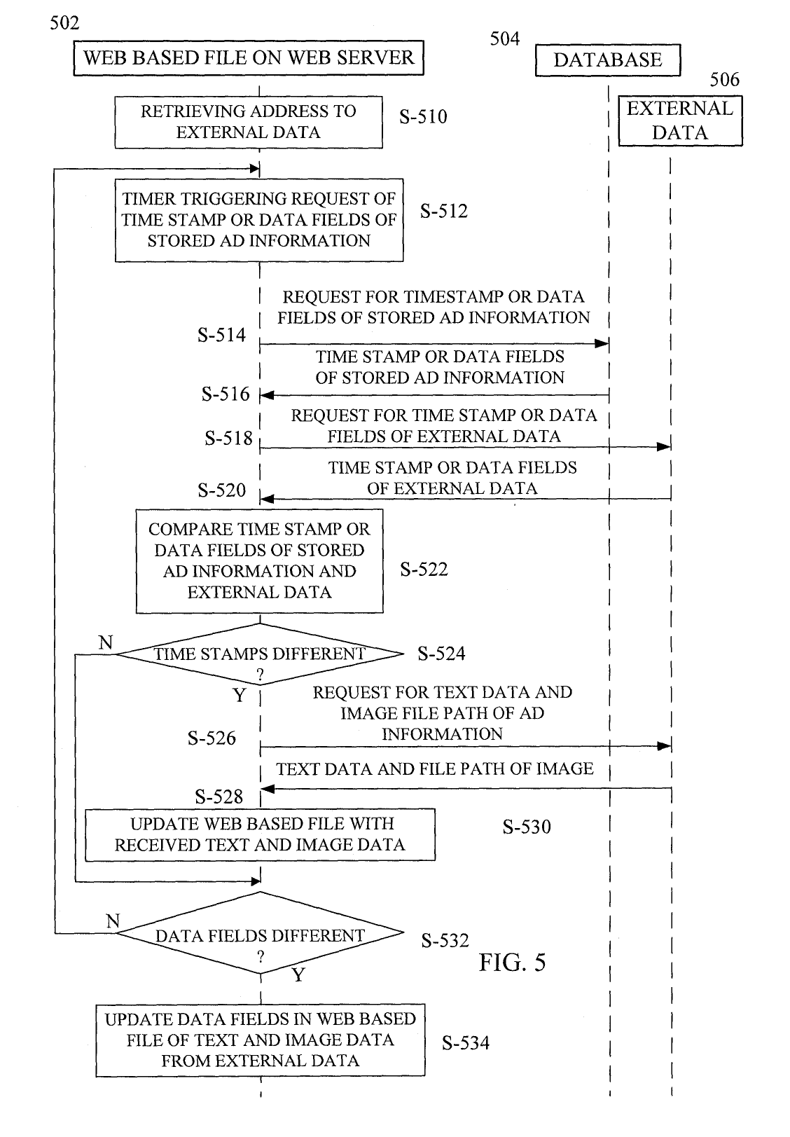

Also, after being generated in step S-230, the web based ad file on the web server can update information, without any interaction of either the advertiser or the ad server. The web based ad file will be discussed more in relation to FIGS. 4 and 5, below.

In the subsequent step the ad server creates a connection between the ad information and the web based ad file in step S-232. In this step, text data ID and storage paths to image data are stored in the web based ad file.

It can here be added that the web based ad file thus stores a text data ID. This text data ID refers to certain text data in the database 206. This text data may further refer to other text data possibly located in one or more other databases, which other text data can be accessed from the database 206 using additional text data identifiers.

Moreover, in following step S-234 the web based ad file is then stored by the ad server 204 in an area that is accessible by the web server 106. The ad server may now link the web base file to the proxy web page in step S-236.

The ad server may transfer the link between the web based ad file and the proxy web page to the database in step S-238. Having received at least data about link or the link itself the database can then store the link to be accessible from the web server 106.

In this way a release of an ad may be carried out according to some embodiments of the present invention.

According to an alternative embodiment, the web based ad file is linked directly to the web address of the dedicated display space, without the passage through a proxy web page. This embodiment is not separately illustrated, rather, as most steps of such a method coincide with the steps as illustrated in FIG. 2, reference is made to said figure.

The step of linking the web address of the dedicated ad space and the web based ad file may be performed in advance, i.e. before performing step of the method as being described. Alternatively it can be performed as an updated step S-236. Linking the web address of the dedicated display space and the web based ad file may thus be performed instead of linking the web based ad file to the proxy web page.

In case the proxy web page is not used, steps S-212 and S-214 of FIG. 2, would not be used either. In addition, step S-238 would rather be sending the link between the web address of the dedicated ad space and the web based ad file to the database.

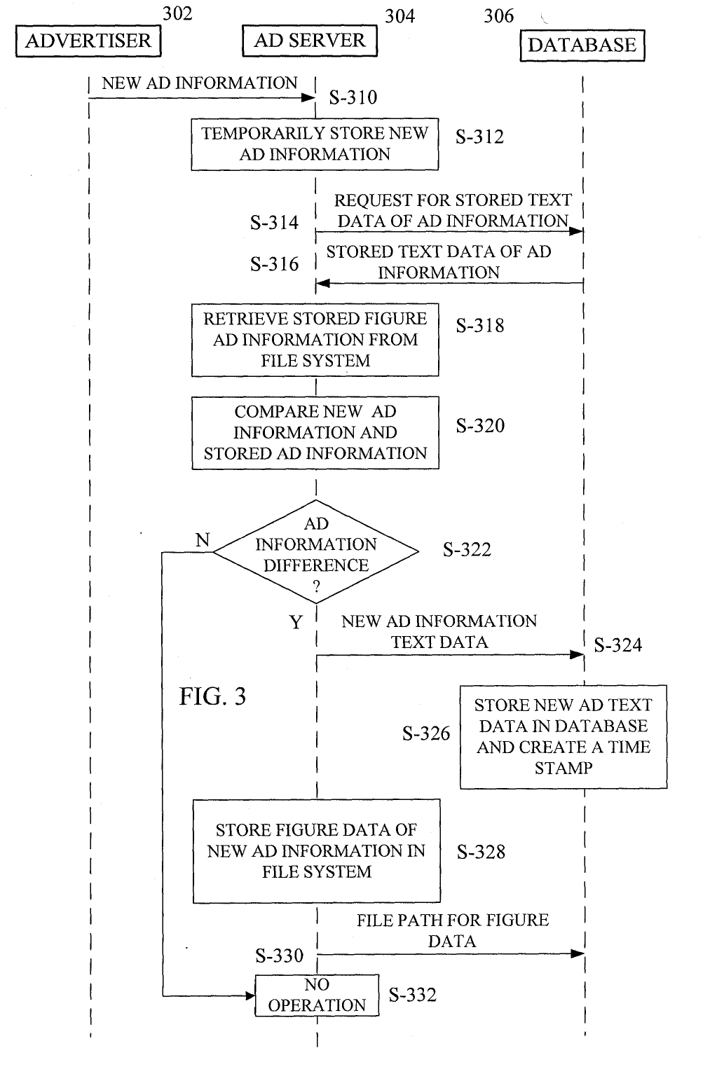

With reference to FIG. 3 illustrating an information flow diagram of steps related to a method in a server application of updating ad information of an ad for a dedicated ad space of a web site.

This method thus relates to updating of information of an ad, which information is presented in the dedicated display space in case a web page browser 112 visits the web address of the web site and the ad.

The method for updating may start by the ad server 304 receiving new ad information from an advertiser 302 in step S-310. New ad information is here an example of first ad information of the accompanying claims. New ad information does not necessarily mean that this ad information is new in relation to other information that may already be available to the ad server. It refers to that additional or some ad information is obtained from the advertiser 302 in step S-310.

The ad server may now temporarily store said new ad information in step S-312. This step is thus optional, but may be performed for maintaining an improved safety level.

The ad server now having received new ad information needs access to already available data in order to perform a comparison to determine whether the data as received in step S-310 is new or not. For this reason the ad server 304 now sends a request for stored data text data of ad information to the database 306 in step S-314. Generally, text data is stored in the database 306 where as image data is kept stored in a file system, mainly for spatial reasons.

In step S-316 the ad server obtains the text data itself of the stored ad information.

The ad server may then retrieve image data of the stored ad information from the file system in step S-318. Thereafter the ad server can perform a comparison of the new ad information and the stored ad information in step S-320.

The ad server 304 can then determine whether there is a difference or not between the text data, image data or other ad information data as compared in step S-322.

In the case there is a difference detected between either the text data or the image data of the new ad information and the stored ad information, the ad server can send the text data of the new ad information to the database 306 in step S-324.

The ad server may for this step retrieve the temporarily stored new ad information, if stored in the foregoing step S-312.

The database may in any case store said text data of the new ad information, upon which additional time related data is created, in step S-326. This additional time related data may be in the form of a time stamp being a marker of the time instance at which data was stored in the database. The additional time related data may alternatively comprise a counter of which the version of the ad information. This counter may thus be a version incrementing counter, which is updated each time ad information is added. These types of time related data will be used down below in order to assess which data is more updated than others.

The ad server 304 stores image data of the new ad information in the file system in step S-328. Thereafter, the ad server may transfer a file path of the stored image data to the database in step S-330.

In the case no difference is detected between either the text data or the image data of the new ad information and the stored ad information, in step S-322, the ad server has no reason and is not capable to perform an update since the two sets of ad information, i.e. new ad information and stored ad information are the same, for which reason step S-332 is no operation.

It should further be noted that receiving ad information in step S-310 can comprise receiving an ad information selection indicator. For instance, the advertiser can provide sets of ad information to the ad server, where each set can comprise text files and image related files. In addition, each set may also comprise an ad information selection indicator. This ad information selection indicator can relate ad information to a detected event, which can be used by the web based ad file to decide which ad information to present, in addition to the comparison of data fields or time related data, as will be further described below.

Having presented information flow diagrams of releasing an ad and updating ad information, the following information flow diagrams illustrates steps related to a method in a server application for maintaining that ad information of a release of an ad is kept updated.

With reference to FIG. 4 presenting information flow between a web based ad file 402 on a web server 106 and database 404. It should be noted that the web based ad file was introduced in connection to FIG. 2.

It can be noted that when visiting a web site having an ad managed according to embodiment of the present invention, the information that is presented by the display space of the ad is managed by the web based ad file having access to text and image, via file paths to file system(s) and one or more databases. The web based ad file as described herein may be implemented as an autonomous application running more or less independent or other application once text data and image data having various time related data is provided.

The web base file 402 initially typically provides current ad information for displaying of the ad, in step S-410.

Since this method ensures that the presentation of ad information is up to date essentially in real time, reference data in the form of data that is currently displayed is therefore provided in step S-410.

The web based ad file may then be triggered by a timer trigger to request time related data such as a time stamp or a counter of the stored data, in step S-412.

The request itself can be sent in step S-414 to the database 404 having access to the time stamp of the stored ad information, the reason being that time related data was created when storing text data in the database 306 in step S-326 as indicated in FIG. 3.

The database 404 can now send the time stamp of the ad information to the web based ad file on the web server in step S-416.

Having access to the data as currently displayed and the data as stored, the web based ad file can now perform a comparison of the time stamp or counter of the current ad information and the time stamp or counter of the stored ad information, in step S-418.

In the case there is a difference detected between the time stamp or counter of the current ad information and the time stamp or counter of the stored ad information in step S-420, the web based ad file can then send a request for text data and one or more file paths to image data, to the database 404 in step S-422. Having access to said file paths the database sends text data and image file path to the web based ad file 402 in step S-424, which text data and file paths are received by the web base file 402. Having access to both text data and figure data the web based ad file can now update the text data and figure file paths in the web based ad file in step S-426.

It must be emphasized that updating of ad information in the web based ad file, automatically provides web page browser of each visitor 112 with an updated display. Since the timer triggering the web based ad tile can be set to frequent triggering, an essentially real time updating can be achieved of the web page of the web site that is visited. The triggering can for instance be performed on the basis of seconds, such that every 5 seconds and possibly even more often. The frequency of update can be determined in collaboration with the web site having the ad. In addition, the triggering can of course be set to any time length longer than said time intervals.

Down below will be presented an information flow diagram of FIG. 5, in which ad information is being provided from data external to the web server or possibly directly connected databases. Such data will herein be called external data.

The information that is sent in the information flow diagram is sent between the web based ad file 502 situated on a web server 106, a database 504 and external data 506.

In step S-510 the web based ad file retrieves the address to external data. This piece of information is typically provided by the advertiser in step S-218 of providing ad information. Similar to step S-412 in FIG. 4 the web based ad file 502 may now be timer triggered in step S-512 to request a time related data in the form of time stamp or a counter. It can be noted that the timer triggers the web based ad file recurrently to ensure that the ad information is up to date, which may occur in essentially real time.

Now, being triggered to request, the web based ad file accordingly sends a request for time related data in the form of a time stamp or a counter, or the data fields themselves, of the stored information, in step S-514 to the database 504. The database having access to the time related data and data fields of the stored ad information, can now send the time related data or the data fields to the web based ad file in step S-516.

Needless to say, both time related data and the data fields may be requested and thereafter sent.

Having received the time related data or the data fields, the web based ad file 502 now turns to the external data for a request of time related data and/or data fields of the external data, which request is sent by the web based ad file on the web server to the external data, in step S-518.

It can further be mentioned that external data 506 refers to a node or another location comprising or at least having access to said external data.

The external data 506 now sends time related data and/or the data fields to the web based ad file in step S-520.

At this stage the web based ad file can perform a comparison between the time related data or data fields of the stored ad information and the external data, in step S-522.

In the case the web based ad file can detect a time related adapt difference for instance time stamp or counter difference between the stored ad information and the external data, in step S-524, the web based ad file 502 now sends a request for text data and image file path of the ad information from the external data 506 in step S-526.

The external data 506 can send the text data and one or more file paths to one or more images of the ad information to the web based ad file 502, in step S-528.

Having received the ad information in the form of text data and/or figure file path data, the web based ad file now performs an update with the received text and image data in step S-530. The received ad information may be in the form of file paths, so that the web based ad file updates the data fields for the text data and figure data to be displayed.

In the subsequent step, or the step following a detection of no time related data difference in step S-524 as performed by the web based ad file, it is determined whether there is a difference between the data fields of the stored ad information and the external data, in step S-532.

If, on the one hand, the web based ad file detects at least one data field difference, in step S-532 the web based ad file now updates the data fields in the web based ad file of the text data and the image data from the external data, in step S-534. The at least one data field difference may comprise a Boolean operator state, such as “Yes” or “No”, or the state of a logical flag.

If on the other hand, there is no data field difference detected between the stored ad information and the external data, in step S-532, the following step to perform by the web based ad file is step S-512 of timer triggering the request for time related data or data fields of the stored ad information. In the case external data comprises multiple sets of ad information in step S-528, the selection of ad information to display may be determined based on detection of an event. The step of updating the access to ad information may in this case comprise updating the access to ad information that is related to the detected event in step S-534. The ad information related to the detected event may here comprise ad information selection indicator that serves to relate a set of ad information to the detected event. Examples of ad information selection indicator comprise an event related logical flag and a unique value of a parameter.

In the event of cold weather, for instance, a flag can indicate ad information about warm clothes to be selected. Ad information to be displayed can be made dependent on an arbitrary for instance the results of a sports game. In case of loss of the sports game ad information of a first kind can be chosen to be displayed, and in case of a win, ad information of a second kind can be chosen to be displayed. Needless to say, a great number of relationships between events and ad information can be envisaged.

Even though it may be stated that the web based ad file 402, 502 performs certain steps within methods herein described, it shall be remembered that it is in fact the web server on which the web based ad file resides that performs said steps based on instructions from the web based ad file. It has thus been described and explained how to ensure that the ad information that is presented in the display space is up to date. As mentioned above, the frequency of timer triggering can be set to a time duration in the order of a second for which reason the ad information that is being displayed is updated on equally often.

It must be emphasized that the update of the web page that a visitor 112 is visiting by using a web browser is performed without input the need of any input from the visitor. This is the in contrast to numerous methods of prior art techniques, in which an explicit refreshing of the web page is required, in the case plug-in software or third party program code is not used.

Ad information can thus be updated such that a visitor will experience a dynamic advertisement. By applying embodiments of the present invention, this is made possible without the need to install, or accept installing of, plug-ins or third party program code on the visitor's computer, which certainly is an advantage since installing plug-ins and third party program code is hazardous and a pronounced risk for the reason that unwanted program code such as viruses, worms, Trojan Horses and the like, may as well or instead, be installed, which may threaten the entire computer with contents.

Also, it can be noted that the step of obtaining ad information the method of releasing an ad, may comprise obtaining data related to the size of the dedicated ad space. The data related to the size can instruct the web server to configure the ad to adopt in size according to the space that is available for the ad. Automated size adjustment can thus be instructed by the advertiser input data.

Moreover, the size of the ad can alternatively be defined by defining the size as a predefined size by the advertiser input data.

The size of the ad may alternatively be dynamic and change with time, again as defined by the advertiser input data.

Herein mentioned web servers and ad servers, refer to web server and ad server program code or software. An ad server program code and a web server program code can run at the same physical server or hardware.

Also, while the processes described above and as illustrated in the drawings are shown as steps within information flow diagrams, this was done solely for the sake of illustration. Accordingly, it is contemplated that some steps may be added, some steps may be omitted and the order of the steps may be re-arranged.

It is explicitly stated that the above aspects of the invention may be combined in several different embodiments or in one singular embodiment.

It must be emphasized that the present invention can be varied in many ways. The presented embodiments of the present invention are only a few examples of the variety of embodiments that are comprised within the present invention.

Among the advantages of at least some of the embodiments of the present invention can be mentioned:

It is an advantage that an advertiser can quickly and easily update ad information.

It is also an advantage that such ad information can be updated in essentially real-time.

It is a further advantage that a web site having an ad, does not need to be updated in order to present an updated version of the ad. Updating of ad is thus managed independent of the updating of the web page of a web browser.

Dynamic advertisements can be presented without the need to install, or accept installing of, plug-ins or third party program code on the visitor's computer, which certainly is an advantage since installing plug-ins and third party program code is a hazard and a pronounced risk for the reason that unwanted program code may as well or instead be installed, which may threaten the entire computer with contents.

1. A method in a server application of releasing an ad for a dedicated ad space of a web site, comprising the steps of:
obtaining advertiser input data comprising data of selecting the dedicated ad space,
receiving ad information defining the ad from the advertiser,
generating a web based ad file based on the received advertiser input data by an ad server, wherein the web based ad file is configured to disclose the ad when being linked to,
storing the web based ad file in a storage unit accessible from a web server,
determining in the web based ad file a connection to the received ad information, and
linking a web address of the dedicated ad space and the web based ad file, for releasing the ad in the dedicated ad space essentially in real-time by a web server upon visiting the web site comprising the dedicated ad space.

2. The method in a server application of releasing an ad according to claim 1, wherein the step of obtaining advertiser input data further comprises obtaining selection of a web based ad file template having data fields for defining the web based ad file, and wherein the step of generating a web based ad file comprises generating the web based ad file using the web based ad file template, based on advertiser input data.

3. The method in a server application of releasing an ad of according to claim 1, wherein the step of receiving ad information comprises receiving text data, and wherein the method further comprises storing the received text data in a database.

4. The method in a server application of releasing an ad of according to claim 1, wherein the step of receiving ad information comprises receiving image data, and wherein the method further comprises storing the received image data in a data storage that is accessible by the web server.

5. The method in a server application of releasing an ad according to claim 1, wherein the step of obtaining advertiser input data, comprises obtaining data related to the size of the dedicated ad space.

6. The method in a server application of releasing an ad according to claim 1, wherein the step of linking the web address of the dedicated ad space and the web based ad file, comprises providing an uplink from the web address of the dedicated ad space via a proxy web page redirecting the uplink from the web address of the dedicated ad space to said web based ad file.

7. The method in a server application of releasing an ad according to claim 1, wherein the step of linking the web address of the dedicated ad space and the web based ad file, comprises providing a downlink from the web based ad file to the web address of the dedicated ad space, for providing a direct access for the web based ad file to the web address of the dedicated ad space.

8. The method in a server application of releasing an ad according to claim 1, further comprising obtaining meta tags related to the ad information, enabling indexing of the web based ad file by search engines.

9. The method in a server application of releasing an ad according to claim 1, wherein the step of receiving the ad information comprises receiving an address of a dataflow of ad information.

10. A method in a server application of updating ad information of an ad for a dedicated ad space of a web site, wherein a web address of the dedicated ad space is linked to a web based ad file configured to disclose the ad when being linked to, where the ad is based on ad information that is stored and accessible by the web based ad file, the method comprising the steps of:
receiving first ad information,
obtaining information at least related to second ad information stored in a data source,
comparing first ad information and the information at least related to second ad information stored in the data source, and
updating the second ad information stored in the data source according to the received first ad information, in the case a difference is determined in the comparison,
so that the ad based on second ad information is being updated essentially in real-time.

11. The method in a server application for updating ad information according to claim 10, further comprises storing said first ad information in a database, wherein storing creates time related data that is related to time of storing said first ad information.

12. The method in a server application for updating ad information according to claim 11, wherein time related data that is created in the step of storing said first ad information in a database, comprises a counter or a time stamp.

13. The method in a server application for updating ad information according to claim 10, wherein ad information in the step of receiving first ad information comprises an ad information selection indicator.

14. The method in a server application for updating ad information according to claim 13, wherein the ad information selection indicator comprises an event related logical flag or a unique parameter value.

15. A method in a server application for maintaining that ad information of a release of an ad is kept updated, essentially in real-time for a dedicated ad space of a web site, wherein a web address of the dedicated ad space is linked to a web based ad file configured to disclose the ad when being linked to, where the ad is based on ad information that is stored and accessible by the web based ad file, the method comprising the steps of:
obtaining information at least related to first ad information,
obtaining information at least related to second ad information stored in a data source,
comparing data fields or time related data of information at least related to first ad information and the information at least related to second ad information stored in the data source, and
updating the access to ad information in the web based ad file, based on said comparison of data fields or time related data.

16. The method in a server application for maintaining that ad information of a release of an ad is kept updated according to claim 15, wherein the step of updating comprises updating the access to the first ad information, in the case a difference is detected in the data fields or in said time related data.

17. The method in a server application for maintaining that ad information of a release of an ad is kept updated according to claim 15, further comprising obtaining detection of an event, and wherein the step of updating comprises updating the access to ad information related to the detected event.

18. The method in a server application for maintaining that ad information of a release of an ad is kept updated according to claim 17, where the ad information related to the detected event comprises a first ad information selection indicator, and wherein the step of updating comprises updating the access to ad information related to the detected event, is performed according to the first ad information selection indicator.

19. The method in a server application for maintaining that ad information of a release of an ad is kept updated according to claim 18, wherein the first ad information selection indicator comprises an event related logical flag or a unique parameter value.
